(19) United States
(12) Patent Application Publication
(10) Pub. No.: US 2014/0034494 A1
(43) Pub. Date: Feb. 6, 2014

(54) BLOOD GLUCOSE METER ADAPTED FOR MOBILE DEVICES

(71) Applicants: SHIH-MING CHUANG, New Taipei City (TW); HUNG-KUANG HSU, New Taipei City (TW)

(72) Inventors: SHIH-MING CHUANG, New Taipei City (TW); HUNG-KUANG HSU, New Taipei City (TW)

(73) Assignee: PU YUAN BIOTECH CO., LTD, Taipei City (TW)

(21) Appl. No.: 13/661,389

(22) Filed: Oct. 26, 2012

(30) Foreign Application Priority Data
Aug. 3, 2012 (TW) 101214971

(51) Int. Cl. G01N 27/26

(52) U.S. Cl. 204/403.02

(57) ABSTRACT

The present invention relates to a blood glucose meter adapted to work cooperatively with a mobile device. Generally, a conventional mobile device is designed to transmit music or sound stored therein to a headset via its headset jack and also is enabled to receive music or sound through a microphone thereof for storage. Accordingly, in addition to the aforesaid interface for music/sound transmission, the headset jack is used and programmed to communicate with a blood glucose meter for transmitting signal and data therebetween, and thereby, the blood glucose meter is enabled to transmit data to the mobile device or can be controlled thereby simply by plugging the blood glucose meter into the headset jack of the mobile device.

### FIELD OF THE INVENTION

The present invention relates to a blood glucose meter adapted to work cooperatively with a mobile device, and more particularly, to a blood glucose meter capable of transmitting data to a mobile device or being enabled to be controlled thereby simply by plugging the blood glucose meter into the headset jack of the mobile device.

### BACKGROUND OF THE INVENTION

Nowadays, chronic diseases, such as diabetes, are becoming more and more common in our modern society. Since such chronic diseases are long-term conditions, the treatment generally involves a long-term monitoring of the patient's physical attributes and also certain on-site emergency examinations. However, if the monitoring or the examinations are performed in a traditional medical therapy unit, the patient's specimen will be cultured, process so as to react with specific enzymes in laboratory tests that it generally will take a conceivable long period of time just to obtain the test results, and thus can be a torment mentally and physically for patients. Nevertheless, following the advance of biomedical technology, more and more self-inspection apparatuses are becoming available for chronic disease patients to perform the required monitoring and examinations by themselves at home, and then provide the results of such monitoring and examinations lately to their doctors for allowing the doctors to analyze the test results and thus treat the diseases properly.

Please refer to FIG. 1, which is a block diagram showing a conventional blood glucose meter that is communicating wirelessly through a wireless transmission unit with a mobile device. As shown in FIG. 1, the test result of the blood glucose meter 1 can be transmitting to the mobile device 2 via either a wire or a wireless means. That is, the data of the blood glucose meter 1 can be send to the mobile device 2 either through a Bluetooth unit or a Wi-Fi unit in a wireless communication manner, or even through a RS-232 connector wiring or USB connector wiring in a wired communication manner. Generally, a mobile device 2 is composed of a micro control unit 21, a wireless transmission unit 22, a display unit 24, and a power unit 23, while a conventional blood glucose meter 1 that is connected wirelessly is a device composed of a micro control unit 11, a wireless transmission unit 12 and a power unit 13, by that operationally, the glucose level measured by the blood glucose meter 1 is capable of transmitting to wireless transmission unit 22 of the mobile device 2 through its wireless transmission unit 12, as shown in FIG. 1, whereas each of the two wireless transmission units can be a Bluetooth device or a Wi-Fi device.

By connecting the conventional blood glucose meter 1 to the mobile device 2 either in a wireless manner using the wireless transmission units 12, and 22, or in a wired manner via USB connector wiring, such data transmission generally involves the use of some complex communication protocols, and the cooperation of many electronic parts, so that it is not only complicated, but also can be very costly. Furthermore, since there are still plenty of mobile devices 2 that are not equipped with wireless transmission unit 22 such as Bluetooth unit or Wi-Fi unit, or even may not have USN connections, the usability of those conventional blood glucose meters 1 are greatly restricted.

On the other hand, since almost all the mobile devices are equipped with headset jack for audio input and output, it is intended to provide a blood glucose meter capable of enabling a signal transmission with a mobile device through the headset jack of the mobile device.

### SUMMARY OF THE INVENTION

In view of the disadvantages of prior art, the primary object of the present invention is to provide a blood glucose meter, capable of transmitting its measurement data to a mobile device or being enabled to be controlled thereby to perform a measurement simply by plugging the headset plug of the blood glucose meter into the headset jack of the mobile device, or by connecting he blood glucose meter to the mobile by wire or wireless, and thus establishing a low-cost external blood glucose meter that is able to enable a rapid and easy communication with a mobile device.

To achieve the above object, the present invention provides a blood glucose meter adapted to be plugged in to a headset jack of a mobile device so as to electrically connect to the mobile device for transmitting electric signals therebetween, the blood glucose meter comprising:
a headset plug, for plugging into the headset jack of the mobile device so as to enable an electrical connection and electric signal transmission therebetween;
a socket unit, for receiving a glucose test strip, capable of generating an electric signal according to an electrochemical reaction on the glucose test strip;
a signal input unit, for receiving a control signal from the mobile device via the headset plug;
a micro control unit, for performing a calculation based upon the electric signal from the socket unit and the control signal from the signal input unit so as to output an audio signal and a frequency signal accordingly; and
a signal output unit, for outputting the audio signal and the frequency signal of the micro control unit;
wherein, the blood glucose meter is programmed to be controlled by a software embedded in the mobile device, and thereby, the audio signal and the frequency signal of the micro control unit in the blood glucose meter are assessable to the mobile device so as to be displayed on a display unit of the mobile device for showing the result of a blood glucose testing performed by the blood glucose meter; and consequently, the blood glucose meter is substantially an external device capable of connecting electrically to the mobile device via the headset jack thereof.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a block diagram showing a conventional blood glucose meter that is communicating wirelessly through a wireless transmission unit with a mobile device.

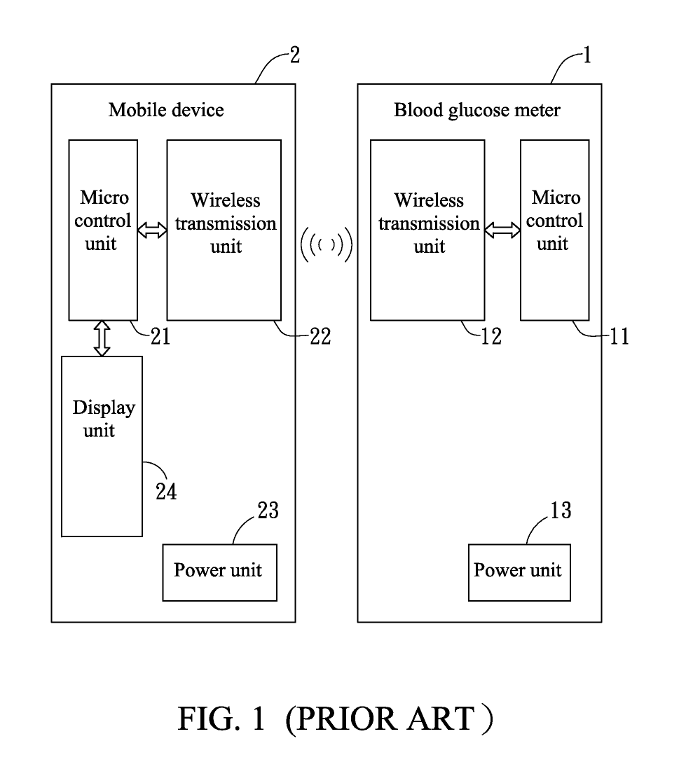

FIG. 2 is block diagram showing a blood glucose meter of the present invention that is adapted to plug into a headset jack of a mobile device.

FIG. 3 is a front view of a blood glucose meter according to an embodiment of the present invention.

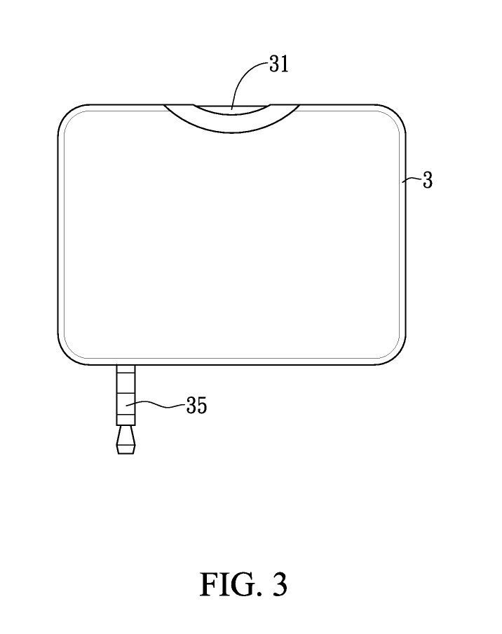

FIG. 4 is a front view of a blood glucose meter of the present invention that is connected to a smart phone.

FIG. 5 is a front view of a blood glucose meter of the present invention that is connected to a tablet computer.

FIG. 6 and FIG. 7 are schematic diagrams showing an extension cord that is adapted to connect a headset jack of a mobile device to the headset plug of a blood glucose meter of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

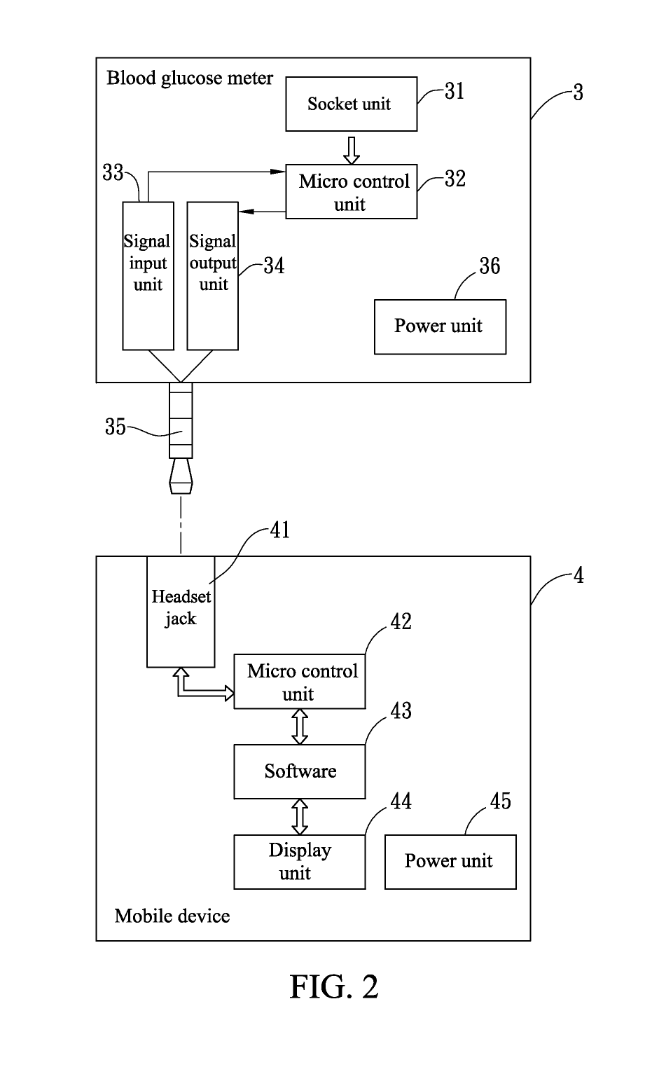

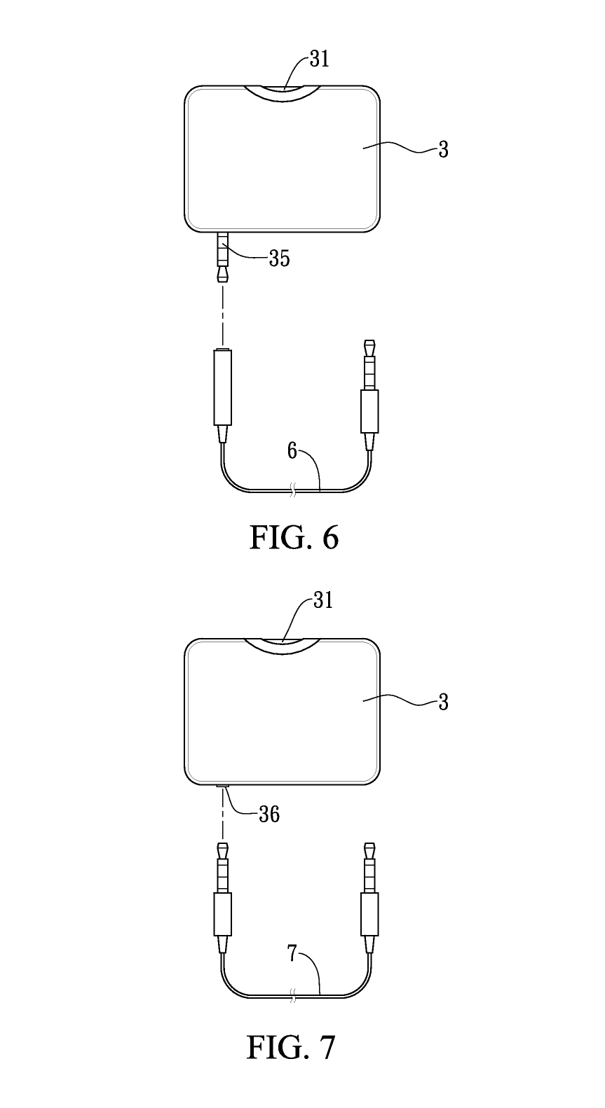

Please refer to FIG. 2, which is block diagram showing a blood glucose meter of the present invention that is adapted to plug into a headset jack of a mobile device. As shown in FIG. 2, there is a blood glucose meter 3 that is adapted to be plugged into a headset jack 41 of a mobile device 4 so as to electrically connect to the mobile device 4 for transmitting electric signals therebetween. The blood glucose meter 3 comprises: a headset plug 35, for plugging into a headset jack 41 of the mobile device 4 so as to electrically connect to the mobile device 4 for enabling a signal transmission; a socket unit 31, for receiving a glucose test strip, capable of generating an electric signal according to an electrochemical reaction on the glucose test strip; a signal input unit 33, for receiving a control signal from the mobile device 4 via the headset plug 35; a micro control unit 32, for performing a calculation based upon the electric signal from the socket unit 31 and the control signal from the signal input unit 33 so as to output an audio signal and a frequency signal accordingly; and a signal output unit 34, for outputting the audio signal and the frequency signal of the micro control unit 32 via the headset plug 35; wherein, the blood glucose meter 3 is programmed to be controlled by a software 43 embedded in the mobile device 4, and thereby, the audio signal and the frequency signal of the micro control unit 32 in the blood glucose meter are assessable to the mobile device 4 so as to be displayed on a display unit 44 of the mobile device 4 for showing the result of a blood glucose testing performed by the blood glucose meter; and consequently, the blood glucose meter 3 is substantially an external device capable of connecting electrically to the mobile device 4 via the headset jack 41 thereof. It is noted that the display unit 44 can be a liquid crystal display. In an embodiment of the invention, the headset jack 41 can be connected to the headset plug 35 using an extension cord, as the extension cords 6 and 7 shown respectively in FIG. 6 and FIG. 7. In FIG. 6, one end of the extension cord 6 is configured with a male connector while the other end is configured with a female connector; and in FIG. 7, both ends of the extension cord 7 are respectively configured with male connectors, whereas the original headset plug of the blood glucose meter 3 is replaced by a headset jack 36.

Both the blood glucose meter 3 and the mobile device 4 are equipped respectively with power units 36 and 45, in which the mobile device 4 can be a device selected from the group consisting of: a cellular phone, a smart phone, a personal digital assistant (PDA), a tablet computer, and a notebook computer.

In addition, the software can be a speech recognition program or a signal recognition program whichever is able to analyze and convert the audio signal or the frequency signal into binary (digital) form of 0's and 1's. Moreover, the software can be adapted to operate under various operation system, including Windows, iOS, Android, and so on.

It is noted that aforesaid signal input unit 33 is not essential for the blood glucose meter 3 of the invention, since the blood glucose meter 3 is very capable of performing a glucose level measurement independently, and then transfers the measurement result to the mobile device 4 for display. That is, the blood glucose meter 3 is able to work independently without being directed and controlled by the control signal of the mobile device 4 that is inputted via the signal input unit 33.

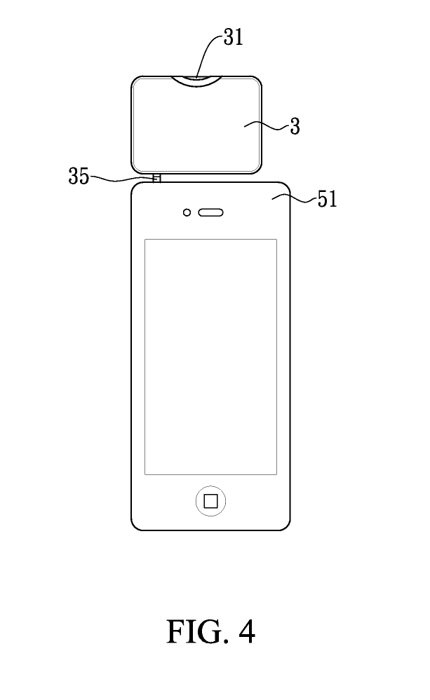

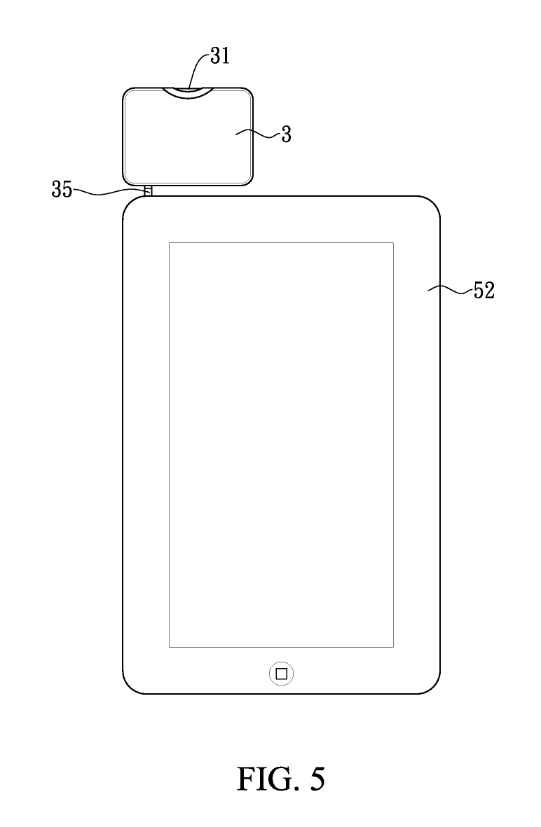

Please refer to FIG. 4 and FIG. 5, which are respectively a front view of a blood glucose meter of the present invention that is connected to a smart phone, and a front view of a blood glucose meter of the present invention that is connected to a tablet computer. It is noted that all the smart phones 51 and tablet computers 52, regardless the operation system they use or the specifications of their communication ports, are generally configured with a line-in or a line-in-and-line-out, referring as the headset jack hereinafter. Thus, operationally, the mobile device of the present invention is enabled to output via its headset jack 35 a control signal to the signal input unit 33 of the blood glucose meter 3, and then, the blood glucose meter 3 is controlled by the control signal to perform a glucose level measurement process using the socket unit 31 and the micro control unit 32. After completing the measurement process, the measurement result is encoded into an electric signal so as to be send from the signal output unit 34 back to the headset jack 41 of the mobile device 4 via the headset plug 35 of the blood glucose meter 3. Thereafter, the electric signal is received and decoded by the micro control unit 42 of the mobile device 4 so as to display the measurement result in the display unit 44 of the mobile device 4.

On the other hand, the blood glucose meter 3 is very capable of performing the glucose level measurement independently without having to be controlled by the mobile device 4. That is, the blood glucose meter 3 can be designed to be activated or deactivated by an action selected from the group consisting of: inserting a test strip into the socket unit 31 of the blood glucose meter 3, and pressing a button on the blood glucose meter 3. By the aforesaid action, the blood glucose meter 3 is activated to perform a glucose level measurement process, and after completing the measurement process, the measurement result is encoded into an electric signal so as to be send from the signal output unit 34 back to the headset jack 41 of the mobile device 4 via the headset plug 35 of the blood glucose meter 3. Thereafter, the electric signal is received and decoded by the micro control unit 42 of the mobile device 4 so as to display the measurement result in the display unit 44 of the mobile device 4.

With respect to the foregoing description, the blood glucose meter of the present invention, that is adapted to be plugged in to a headset jack of a mobile device, are designed with two operation modes, as following:
First mode: both the blood glucose meter and the mobile device are activated simultaneously while allowing the blood glucose meter to operate under the command of the mobile device, which comprises the steps of:
   (1) enabling a mobile device to issue a control signal to its headset jack for allowing the control signal to be transmitted to a signal input unit of a blood glucose meter via a headset plug;
   (2) enabling the blood glucose meter to access the control signal from the signal input unit so as to execute a corresponding process of glucose level measurement and a process for transferring the result of the measurement; process;
   (3) enabling the blood glucose meter to fed the measurement result, being an electric signal, to a signal output unit where it is further being transmitted to the headset jack of the mobile device via the headset plug; and
   (4) enabling the mobile device to read the measurement result from the headset jack while enabling the mobile device to perform either a process for displaying the measurement result of a process for storing the measurement result.
Second mode: the blood glucose meter is first being enabled to perform a glucose level measurement independently, and then transmits the measurement result to a mobile device for display, which comprises the steps of:
   (1) inserting a test strip into the socket unit of the blood glucose meter, or pressing a button on the blood glucose meter for activating the blood glucose meter to perform a corresponding process of glucose level measurement and a process for transferring the result of the measurement;
   (2) enabling the blood glucose meter to fed the measurement result, being a frequency signal, to a signal output unit where it is further being transmitted to the headset jack of the mobile device via the headset plug;
   (3) enabling the mobile device to read the measurement result from the headset jack while enabling the mobile device to perform either a process for displaying the measurement result of a process for storing the measurement result.

To sum up, the primary object of the present invention is to provide a blood glucose meter, capable of transmitting its measurement data to a mobile device or being enabled to be controlled thereby to perform a measurement simply by plugging the headset plug of the blood glucose meter into the headset jack of the mobile device, or by connecting he blood glucose meter to the mobile by wire or wireless, and thus establishing a low-cost external blood glucose meter that is able to enable a rapid and easy communication with a mobile device.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are ntended to be encompassed by the present invention.

What is claimed is:

1. A blood glucose meter, adapted to be plugged in to a headset jack of a mobile device so as to electrically connect to the mobile device for transmitting electric signals therebetween, the blood glucose meter comprising:
a headset plug, for plugging into the headset jack of the mobile device so as to enable an electrical connection and electric signal transmission therebetween;
a socket unit, for receiving a glucose test strip, capable of generating an electric signal according to an electrochemical reaction on the glucose test strip;
a signal input unit, for receiving a control signal from the mobile device via the headset plug;
a micro control unit, for performing a calculation based upon the electric signal from the socket unit and the control signal from the signal input unit so as to output an audio signal and a frequency signal accordingly; and
a signal output unit, for outputting the audio signal and the frequency signal of the micro control unit;
wherein, the blood glucose meter is programmed to be controlled by a software embedded in the mobile device, and thereby, the audio signal and the frequency signal of the micro control unit in the blood glucose meter are assessable to the mobile device so as to be displayed on a display unit of the mobile device for showing the result of a blood glucose testing performed by the blood glucose meter; and consequently, the blood glucose meter is substantially an external device capable of connecting electrically to the mobile device via the headset jack thereof.

2. The blood glucose meter of claim 1, wherein the mobile device is a device selected from the group consisting of: a smart phone, a personal digital assistant, a tablet computer and a notebook computer.

3. The blood glucose meter of claim 1, wherein the software is a speech recognition program or a signal recognition program, whichever is able to analyze and convert the audio signal or the frequency signal into binary (digital) form of 0's and 1's.

4. The blood glucose meter of claim 1, wherein the display unit is substantially a liquid crystal display.

5. The blood glucose meter of claim 1, wherein the headset jack can be connected to the headset plug using an extension cord.

6. The blood glucose meter of claim 1, wherein the blood glucose meter is designed to be activated/deactivated by an action selected from the group consisting of: inserting a test strip into the socket unit of the blood glucose meter, and pressing a button on the blood glucose meter.

7. A blood glucose meter, adapted to be plugged in to a headset jack of a mobile device so as to electrically connect to the mobile device for transmitting electric signals therebetween, the blood glucose meter comprising:
a headset plug, for plugging into the headset jack of the mobile device so as to enable an electrical connection and electric signal transmission therebetween;
a socket unit, for receiving a glucose test strip, capable of generating an electric signal according to an electrochemical reaction on the glucose test strip;
a micro control unit, for performing a calculation based upon the electric signal from the socket unit so as to output an audio signal and a frequency signal accordingly; and
a signal output unit, for outputting the audio signal and the frequency signal of the micro control unit;
wherein, the blood glucose meter is programmed to be controlled by a software embedded in the mobile device, and thereby, the audio signal and the frequency signal of the micro control unit in the blood glucose meter are assessable to the mobile device so as to be displayed on a display unit of the mobile device for showing the result of a blood glucose testing performed by the blood glucose meter; and consequently, the blood glucose meter is substantially an external device capable of connecting electrically to the mobile device via the headset jack thereof.

8. The blood glucose meter of claim 7, wherein the mobile device is a device selected from the group consisting of: a smart phone, a personal digital assistant, a tablet computer and a notebook computer.

9. The blood glucose meter of claim 7, wherein the software is a speech recognition program or a signal recognition program, whichever is able to analyze and convert the audio signal or the frequency signal into binary (digital) form of 0's and 1's.

10. The blood glucose meter of claim 7, wherein the display unit is substantially a liquid crystal display.

11. The blood glucose meter of claim 7, wherein the headset jack can be connected to the headset plug using an extension cord.
